(19) United States
(12) Patent Application Publication
(10) Pub. No.: US 2019/0061534 A1
(43) Pub. Date: Feb. 28, 2019

(54) ELECTRIC VEHICLE

(71) Applicant: HONDA MOTOR CO., LTD., Tokyo (JP)

(72) Inventors: Hideaki Iwashita, Wako-shi (JP); Mitsuhiro Araki, Wako-shi (JP)

(21) Appl. No.: 16/108,186

(22) Filed: Aug. 22, 2018

(30) Foreign Application Priority Data
Aug. 23, 2017 (JP) 2017-160007

(51) Int. Cl. B60L 11/18

(52) U.S. Cl. CPC B60L 11/182

(57) ABSTRACT

An electric vehicle includes a secondary side control unit configured to switch whether to receive electric power, and to control the amount of reception power on the basis of the amount of electric power to be consumed while the electric vehicle travels to a destination, a current charging rate of the battery, and a target charging rate of the battery.

### CROSS-REFERENCE TO RELATED APPLICATION

This application is based upon and claims the benefit of priority from Japanese Patent Application No. 2017-160007 filed on Aug. 23, 2017, the contents of which are incorporated herein by reference.

### BACKGROUND OF THE INVENTION

### Field of the Invention

The present invention relates to an electric vehicle in which a battery is charged by receiving electric power that is transmitted from a road side facility provided along a road.

### Description of the Related Art

Japanese Laid-Open Patent Publication No. 2015-223859 discloses a device that sets a target value of a charging rate (also referred to as state of charge, SOC) of a battery mounted in a hybrid vehicle. This device estimates an air-conditioning status of the vehicle being at a start of the next travel, and on the basis of an estimation result, changes the target value of the charging rate indicated at an arrival at a destination (that is, at the start of the next travel). Japanese Patent No. 5691939 discloses a non-contact power transmission system for charging a battery provided in an electric vehicle by transmitting electric power from a road side facility provided along a road.

### SUMMARY OF THE INVENTION

In a case of charging a battery by receiving electric power transmitted from a power transmission facility provided outside a vehicle, an electricity fee which is a fee for electric power used is charged. In general, in order to save on the electricity fee, a user of the electric vehicle selects a power transmission facility that charges less for the electricity fee.

In the vehicle according to Japanese Laid-Open Patent Publication No. 2015-223859, charging and discharging of the battery are controlled by controlling an operation of a motor generator, and the battery is not charged by receiving the electric power transmitted from the power transmission facility. Thus, the electricity fee is not incurred. In the electric vehicle according to Japanese Patent No. 5691939, the battery is charged by receiving the electric power transmitted from the road side facility and the electricity fee may be incurred.

In a system according to Japanese Patent No. 5691939, it is not discussed to control the timing of receiving the electric power. Therefore, a user of this system cannot decide the amount of electric power the electric vehicle receives from the road side facility. If the usage fee of the electric power transmitted from the road side facility is higher than the usage fee of the electric power transmitted from a charging station or a house side facility, the user pays more as more electric power is received from the road side facility.

The present invention has been made in view of the above problem, and an object is to provide an electric vehicle that can suppress the amount of electric power received from the road side facility.

The present invention provides an electric vehicle in which a battery is charged by receiving electric power transmitted from a road side facility provided along a road, and the electric vehicle includes a control unit configured to switch whether to receive the electric power, and to control the amount of reception electric power on the basis of the amount of electric power to be consumed while the electric vehicle travels to a destination, a current charging rate of the battery, and a target charging rate of the battery.

According to the above structure, the amount of reception electric power from the road side facility is controlled on the basis of the amount of electric power to be consumed while the electric vehicle travels to the destination and the target charging rate; therefore, the electric power is not received from the road side facility more than necessary. If the usage fee of the electric power transmitted from the road side facility is higher than the usage fee of the electric power transmitted from a charging station or a house side facility, the user pays less by decreasing the proportion of the electric power that is received from the road side facility.

The electric vehicle according to the present invention may further include a charging rate designating device configured to designate the target charging rate in accordance with a manual operation.

By the above structure, the user can select whether the amount of reception electric power from the road side facility is increased or minimized, while considering a driving plan or the like that is carried out after reaching the destination. As a result, the use of the electric vehicle becomes more convenient.

The electric vehicle according to the present invention may further include a power reception possibility designating device configured to designate whether to receive the electric power in accordance with a manual operation, wherein the control unit is configured to switch whether to receive the electric power in accordance with the designation of the power reception possibility designating device.

With the above structure, if the user does not want to receive the electric power from the road side facility, the power reception can be blocked by the manual operation. Thus, the user himself can control the electric fee.

In the present invention, the control unit may receive the electric power when the current charging rate is less than or equal to a predetermined value.

By the above structure, the charging is not started until the charging rate becomes less than or equal to a predetermined value that is set in advance; thus, the amount of reception electric power from the road side facility can be minimized.

The electric vehicle according to the present invention may include a notification device configured to notify in accordance with a notification instruction output from the control unit, wherein the control unit may output the notification instruction to the notification device when the target charging rate is not achieved.

By the above structure, the notification is performed if the charging rate may become insufficient before the electric vehicle reaches the destination. Thus, the user can prioritize the charging more than reducing the amount of reception electric power from the road side facility. For example, a scheduled travel route can be changed to a road with a long charging possible section, or the electric vehicle can drop by a charging station for charging.

In the present invention, when the destination is a predetermined place, the control unit may set the target charging rate to a value lower than a value when the destination is not the predetermined place.

By the above structure, if the destination is the place where the usage fee of the electric power is low, for example, the destination is the house or the like, the target charging rate can be set to a minimal value, and the amount of reception electric power from the road side facility can be suppressed.

According to the present invention, the electric power is not received from the road side facility more than necessary.

The above and other objects features and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a structural diagram of a power transmission system including an electric vehicle according to an embodiment;

FIG. 2 is a functional block diagram of a secondary side control unit;

FIG. 3 is a flowchart of a schedule decision process;

FIG. 4 is a flowchart of a first charging process;

FIG. 5 is an explanatory diagram for describing a transition of a charging rate in the first charging process;

FIG. 6 is a flowchart of a second charging process; and

FIG. 7 is an explanatory diagram for describing the transition of the charging rate in the first and second charging processes.

### DESCRIPTION OF THE PREFERRED EMBODIMENTS

A preferred embodiment of an electric vehicle according to the present invention will hereinafter be described in detail with reference to the attached drawings.

Although the embodiment below will describe a system that transmits electric power in a noncontact manner, the present invention is also applicable to a system that transmits electric power in a contacting manner.

### [1. Structure of Power Transmission System 10]

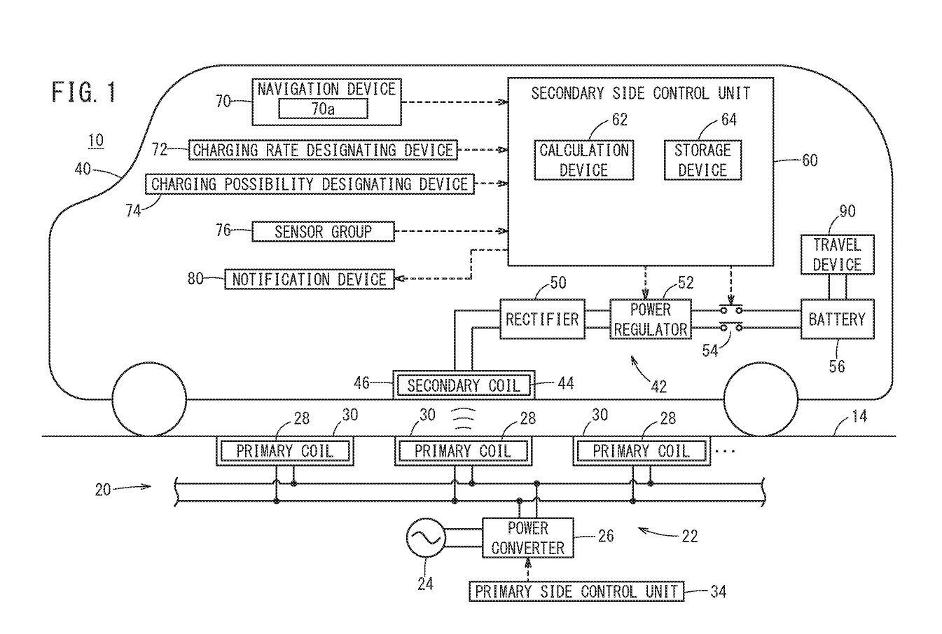

With reference to FIG. 1, a structure of a power transmission system 10 including an electric vehicle 40 according to the present embodiment is described. The power transmission system 10 includes a road side facility 20 provided along a road 14, and the electric vehicle 40. In the power transmission system 10, a battery 56 provided in the electric vehicle 40 is charged with electric power transmitted from the road side facility 20 without contact.

The road side facility 20 mainly includes a power transmission circuit 22 and a primary side control unit 34. The power transmission circuit 22 includes an alternating current power source 24, a power converter 26 that converts an alternating current power supplied from the alternating current power source 24 into a transmission power, and a plurality of primary coils 28. The primary coil 28 is covered with a primary pad 30 and embedded in a surface layer of the road 14. The plurality of primary coils 28 is arranged at predetermined intervals along a direction where the road 14 extends (the left-right direction in FIG. 1). The primary side control unit 34 functions as a predetermined operation unit when a processor such as a CPU reads out and executes programs stored in a memory.

The electric vehicle 40 includes an electric automobile and a hybrid automobile that are driven by electric power supply from the battery 56. The electric vehicle 40 mainly includes a power reception circuit 42, the battery 56, a secondary side control unit 60, a navigation device 70 (destination setting device), a charging rate designating device 72, a power reception possibility designating device 74, a sensor group 76, a notification device 80, and a travel device 90.

The power reception circuit 42 includes a secondary coil 44, a rectifier 50 that rectifies a reception power corresponding to the alternating current power received in the secondary coil 44, a power regulator 52 that regulates a direct current power output from the rectifier 50 into a desired power, and a contactor 54 that switches electric connection/disconnection between the power reception circuit 42 and the battery 56. The secondary coil 44 is covered with a secondary pad 46, and is disposed at a lower surface of the electric vehicle 40.

The battery 56 is formed by, for example, a lithium ion battery. When the contactor 54 is in a connected state to magnetically couple between the primary coil 28 and the secondary coil 44, the battery 56 is charged through the power reception circuit 42.

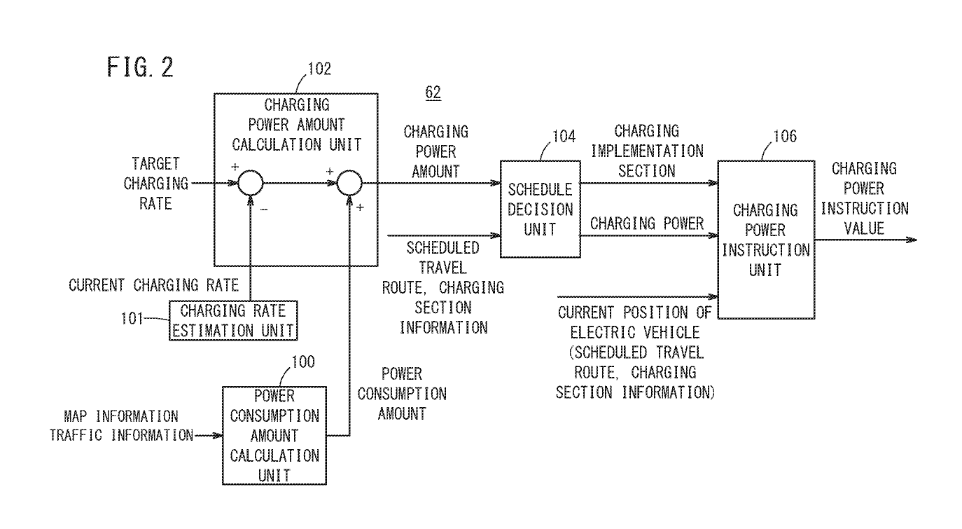

The secondary side control unit 60 is an ECU, and manages a power reception process. The secondary side control unit 60 includes a calculation device 62 and a storage device 64. The calculation device 62 includes a processor such as a CPU, and functions as a predetermined operation unit by reading out and executing programs stored in the storage device 64. Specifically, as illustrated in FIG. 2, the calculation device 62 functions as a consumption power amount calculation unit 100, a charging rate estimation unit 101, a charging power amount calculation unit 102, a schedule decision unit 104, and a charging power instruction unit 106. The storage device 64 stores various programs, and predetermined values, default values, and various pieces of information that are used in various calculations.

The navigation device 70 includes a navigation storage unit 70a that stores map information and charging section information. The map information includes road shape and gradient information, node information regarding intersections, merge points, and branched points, information regarding the presence or absence of traffic lights, positional information regarding stop lines, and the like. The charging section information includes information expressing a charging possible section where the road side facility 20 is provided, information regarding the specification of the road side facility 20, and the like. The navigation device 70 includes an operation switch (including touch panel), a display, and a speaker as a user interface. The navigation device 70 includes an FM receiver or a beacon receiver, and can receive the traffic information provided by the FM multiplex broadcasting, beacon, and the like. The navigation device 70 sets a destination in accordance with a manual input operation on the operation switch, measures a current position (travel position) of the electric vehicle 40 using detection information of a satellite positioning device or sensors included in the sensor group 76, and generates a scheduled travel route from that position to the destination. Then, the navigation device 70 generates a navigation signal including various pieces of information and transmits the navigation signal to the secondary side control unit 60. Note that the navigation device 70 may include functions of the charging rate designating device 72 and the power reception possibility designating device 74 that will be described below.

The charging rate designating device 72 includes an operation switch as a user interface. The charging rate designating device 72 generates a charging rate signal to designate a target charging rate in accordance with the manual input operation on the operation switch, and transmits the charging rate signal to the secondary side control unit 60. The target charging rate is a charging rate that the battery 56 should attain when the electric vehicle 40 reaches the destination set by the navigation device 70. The target charging rate can be set by the user arbitrarily. If the user sets the target charging rate to be higher, in the next start time, the electric vehicle 40 can travel while an electric device (such as an air-conditioner) that consumes much electric power in the battery 56 is operated.

The power reception possibility designating device 74 includes the operation switch (charging switch) as the user interface. The power reception possibility designating device 74 generates a possibility signal (on/off signal) to designate whether the electric power can be received in accordance with the manual input operation on the operation switch, and transmits the possibility signal (on/off signal) to the secondary side control unit 60.

The sensor group 76 includes various sensors that detect the operation of the electric vehicle 40, such as a vehicle speed sensor, an acceleration sensor, and a yaw rate sensor.

The notification device 80 includes a display device that notifies the user of various kinds of information or guidance with a display, and a sound device that notifies various kinds of information or guidance with a sound. The notification device 80 notifies various kinds of information and guidance in accordance with a notification instruction signal output from the secondary side control unit 60.

The travel device 90 includes a driving force device that generates a driving force in accordance with a user's operation on an accelerator pedal, a steering device that steers in accordance with a user's operation of a steering wheel, and a braking device that generates a braking force in accordance with a user's operation on a brake pedal. The driving force device includes an electric motor to which the electric power is supplied from the battery 56 as a driving source. Note that the travel device 90 may be an automated control unit or an assist device in which at least one of the driving force device, the steering device, and the braking device does not depend on the user's operation.

### [2. Charging Operation of Electric Vehicle 40]

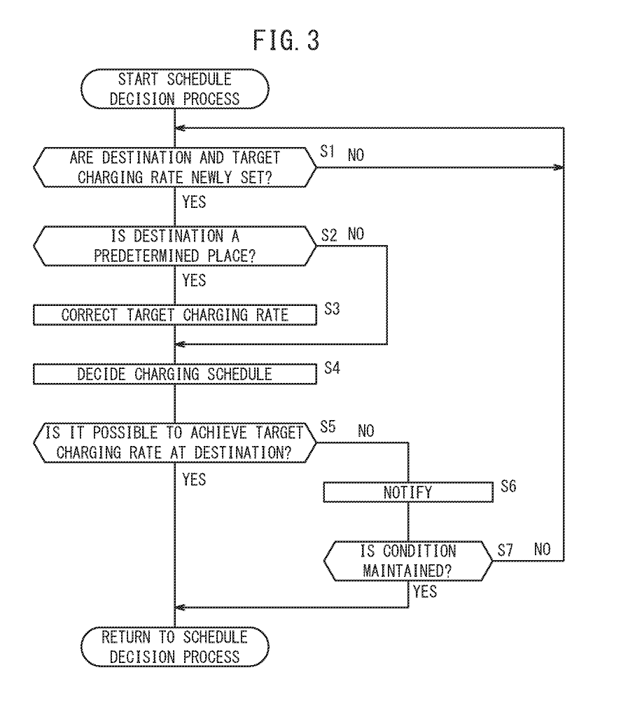

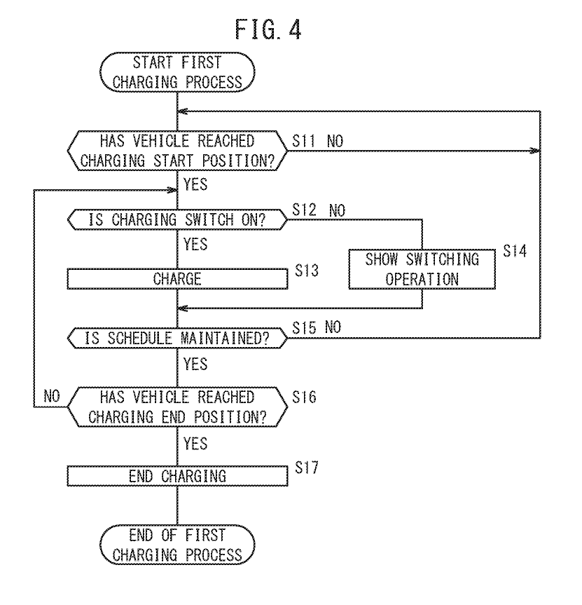

With reference to FIG. 3 and FIG. 4, a basic charging operation of the electric vehicle 40 is described. The electric vehicle 40 performs a schedule decision process (FIG. 3) in which a charging schedule is decided on the basis of the target charging rate or the like, and a first charging process (FIG. 4) in which the battery 56 is charged by receiving the electric power transmitted from the road side facility 20 on the basis of the decided charging schedule.

### [2.1 Schedule Decision Process]

With reference to FIG. 3, the schedule decision process is described. The schedule decision process to be described below is repeated at predetermined time intervals after a main switch of the electric vehicle 40 (such as ignition switch or start switch) is turned on and before the main switch is turned off.

In step S1, the secondary side control unit 60 determines whether the destination and the target charging rate are newly set. When the user inputs the destination by using the operation switch of the navigation device 70, the navigation device 70 transmits the navigation signal to the secondary side control unit 60. In addition, when the user inputs the target charging rate by using the operation switch of the charging rate designating device 72, the charging rate designating device 72 transmits the charging rate signal to the secondary side control unit 60. If the secondary side control unit 60 detects the reception of the new navigation signal or the new charging rate signal (step S1: YES), the process advances to step S2. On the other hand, if the secondary side control unit 60 does not detect the reception of the new navigation signal or the new charging rate signal (step S1: NO), the process of step S1 is repeated.

When the process has advanced from step S1 to step S2, the secondary side control unit 60 determines whether the destination is a predetermined place. The predetermined place is the destination that the user registers in advance in the storage device 64 or the navigation storage unit 70a by using the navigation device 70. For example, usually, the user charges the electric vehicle 40 that is parked at his house or contracted (toll) parking lot (hereinafter referred to as house or the like). In the house or the like, the electric vehicle 40 is parked for a long time; therefore, the charging time is long. As a result, at the house or the like, the battery 56 can be fully charged. In addition, if the electric fee at the house or the like is low, the user prefers charging at the house or the like. For the above reason, in the case where the house or the like is set as the destination, it is preferable that the target charging rate is set to be low so that the amount of electric power received from the road side facility 20 is suppressed. If the destination is the predetermined place such as the house (step S2: YES), the process advances to step S3. On the other hand, if the destination is not the predetermined place (step S2: NO), the process advances to step S4.

When the process has advanced from step S2 to step S3, the secondary side control unit 60 corrects the target charging rate. For example, the storage device 64 stores one of a decrease rate, a decrease amount, and a decrease value of the target charging rate. The calculation device 62 corrects the target charging rate to be a low value by multiplying the target charging rate by the decrease rate, subtracting the decrease amount from the target charging rate, or replacing the target charging rate with the decrease value. At this time, the decrease rate, the decrease amount, and the decrease value may be changed depending on the target charging rate. In addition to the predetermined place, the decrease rate, the decrease amount, and the decrease value for that predetermined place may be set in the storage device 64. In this case, the target charging rate is corrected using the decrease rate, the decrease amount, and the decrease value corresponding to the predetermined place.

When the process has advanced from step S2 or step S3 to step S4, the secondary side control unit 60 decides the charging schedule on the basis of information regarding the target charging rate, the latest charging rate (hereinafter referred to as current charging rate), and the scheduled travel route. A series of processes performed by the calculation device 62 when deciding the charging schedule is described in [2.2] below. After step S4, the process advances to step S5.

In step S5, the secondary side control unit 60 determines whether the target charging rate can be achieved at the destination, assuming that the charging is performed in accordance with the charging schedule. If the target charging rate can be achieved at the destination (step S5: YES), the schedule decision process ends for the time being. On the other hand, if target charging rate cannot be achieved at the destination (step S5: NO), the process advances to step S6.

When the process has advanced from step S5 to step S6, the secondary side control unit 60 transmits the notification instruction signal to the notification device 80. In accordance with the notification instruction, the notification device 80 performs the notification that the target charging rate cannot be achieved at the destination.

In step S7, the secondary side control unit 60 determines whether a condition, such as the destination or the target charging rate, is maintained. If the condition is not changed for a predetermined period after the notification device 80 performs the notification or if the user expresses her/his intention that the condition is not changed by operating the operation switch or the like (step S7: YES), the schedule decision process ends for the time being. On the other hand, if the condition is changed (step S7: NO), the process returns to step S1.

### [2.2 Specific Example of Process in Step S4]

With reference to FIG. 2, the process in step S4 illustrated in FIG. 3 is described in detail. The function units of the calculation device 62 illustrated in FIG. 2 that are related to the process in step S4 are the consumption power amount calculation unit 100, the charging rate estimation unit 101, the charging power amount calculation unit 102, and the schedule decision unit 104.

The consumption power amount calculation unit 100 estimates the amount of electric power necessary for the electric vehicle 40 to travel from the current position to the destination, that is, the amount of electric power to be consumed until the electric vehicle 40 reaches the destination (hereinafter referred to as consumption power amount) on the basis of, for example, the traffic information and the map information related to the scheduled travel route transmitted from the navigation device 70. The consumption power amount may include the power loss and the estimated amount of electric power to be consumed in the air conditioner or other auxiliary machines, for example. The consumption power amount calculation unit 100 estimates the vehicle speed and the driving force that are necessary at each time point until the electric vehicle 40 reaches the destination and calculates the electric power that is necessary (consumed) at that time. Then, the electric power is time integrated and the result is regarded as the consumption power amount.

The charging rate estimation unit 101 estimates the current charging rate of the battery 56. The current charging rate can be estimated by a method in which the charging and discharging currents of the battery 56 are totaled and on the basis of the amount of current, the current charging rate is calculated as disclosed in Japanese Patent No. 5278957, or a method in which the current charging rate is estimated on the basis of an open circuit voltage.

The charging power amount calculation unit 102 acquires the target charging rate transmitted from the charging rate designating device 72, the current charging rate estimated by the charging rate estimation unit 101, and the consumption power amount calculated by the consumption power amount calculation unit 100. Then, the charging power amount calculation unit 102 calculates the amount of electric power that need be charged from the road side facility 20 on the basis of the acquired information (hereinafter this amount of electric power is referred to as charging power amount). Here, the charging power amount is calculated by an expression: (power amount equivalent to target charging rate)−(power amount equivalent to current charging rate)+(consumption power amount).

The schedule decision unit 104 decides the charging schedule so that the charging rate of the battery 56 becomes the target charging rate at the destination, on the basis of the charging power amount calculated by the charging power amount calculation unit 102, and the charging section information and the information regarding the scheduled travel route transmitted from the navigation device 70. The charging schedule includes the information regarding a charging implementation section, a charging start position, a charging end position, and the charging power at each position or the like. The charging implementation section may be one section or a plurality of sections. The request power may be either a fixed value or a variable value in the section. If the target charging rate is not achieved even though the charging power amount is maximized in the entire charging possible sections, the charging rate is made as close to the target charging rate as possible in the following manner: the charging implementation section in the charging schedule is set as the entire charging possible sections and the charging power at each point is maximized.

### [2.3 First Charging Process]

The first charging process is described with reference to FIG. 4. The first charging process described below is performed after the charging schedule is decided in the schedule decision process illustrated in FIG. 3. Since the charging schedule is repeated, the charging schedule may be changed in the middle of the first charging process illustrated in FIG. 4.

In step S11, the secondary side control unit 60 determines whether the electric vehicle 40 has reached the charging start position included in the charging schedule. As illustrated in FIG. 2, the charging power instruction unit 106 acquires information regarding the charging start position in the charging implementation section decided by the schedule decision unit 104, and information regarding the current position of the electric vehicle 40 transmitted from the navigation device 70. By comparing the charging start position and the current position, it is determined whether the electric vehicle 40 has reached the charging start position. If the electric vehicle 40 has reached the charging start position, that is, the electric vehicle 40 is in the charging implementation section (step S11: YES), the process advances to step S12. On the other hand, if the electric vehicle 40 has not reached the charging start position, that is, the electric vehicle 40 is out of the charging implementation section (step S11: NO), the process of step S11 is repeated.

When the process has advanced from step S11 to step S12, the secondary side control unit 60 determines whether the operation switch (charging switch) of the power reception possibility designating device 74 is on. The user expresses his intention to receive the electric power from the road side facility 20 by using the power reception possibility designating device 74. If the operation switch (charging switch) is on (step S12: YES), the process advances to step S13. On the other hand, if the operation switch (charging switch) is off (step S12: NO), the process advances to step S14.

When the process has advanced from step S12 to step S13, the secondary side control unit 60 charges the battery 56. When the charging is started, the secondary side control unit 60 outputs a connection instruction signal to the contactor 54. The contactor 54 becomes a connected state in accordance with the connection instruction. Next, as illustrated in FIG. 2, the charging power instruction unit 106 acquires from the schedule decision unit 104 the information regarding each position in the charging implementation section and the information regarding the necessary charging power at each position. In addition, the charging power instruction unit 106 acquires the information regarding the current position of the electric vehicle 40 from the navigation device 70. Then, the charging power instruction unit 106 decides the necessary charging power at the current position and outputs a power instruction signal expressing an instruction value of the charging power to the power regulator 52. The power regulator 52 regulates a duty ratio, for example, so as to set the charging power of the battery 56 to be the instruction value.

When the process has advanced from step S12 to step S14, the secondary side control unit 60 outputs a guidance instruction signal of the switching operation to the notification device 80. The notification device 80 notifies that the charging from the road side facility 20 is started by switching the operation switch (charging switch) of the power reception possibility designating device 74 from the off state to the on state in accordance with the guidance instruction.

In step S15, the secondary side control unit 60 determines whether the charging schedule is maintained. As described above, the schedule decision process is performed in parallel to the first charging process. If the charging schedule is not changed in the parallel schedule decision process (step S15: YES), the process advances to step S16. On the other hand, if the charging schedule is changed in the parallel schedule decision process, the schedule decision unit 104 outputs the information regarding the new charging implementation section and the new charging power. In this case (step S15: NO), the process returns to step S11. Then, the charging power instruction unit 106 performs the process on the basis of the new charging implementation section and the new charging power.

In step S16, the secondary side control unit 60 determines whether the electric vehicle 40 has reached the charging end position included in the charging schedule. As illustrated in FIG. 2, the charging power instruction unit 106 acquires the information regarding the charging end position in the charging implementation section decided by the schedule decision unit 104 and the information regarding the current position of the electric vehicle 40 transmitted from the navigation device 70. Then, by comparing the charging end position and the current position, whether the electric vehicle 40 has reached the charging end position is determined. If the electric vehicle 40 has reached the charging end position, that is, the electric vehicle 40 is out of the charging implementation section (step S16: YES), the process advances to step S17. On the other hand, if the electric vehicle 40 has not reached the charging end position, that is, the electric vehicle 40 is in the charging implementation section (step S16: NO), the process returns to step S12.

When the process has advanced from step S16 to step S17, the secondary side control unit 60 ends the charging of the battery 56. The secondary side control unit 60 outputs a disconnection instruction signal to the contactor 54. The contactor 54 is disconnected in accordance with the disconnection instruction. Thus, the first charging process ends.

### [3. Transition 1 of Charging Rate of Battery 56]

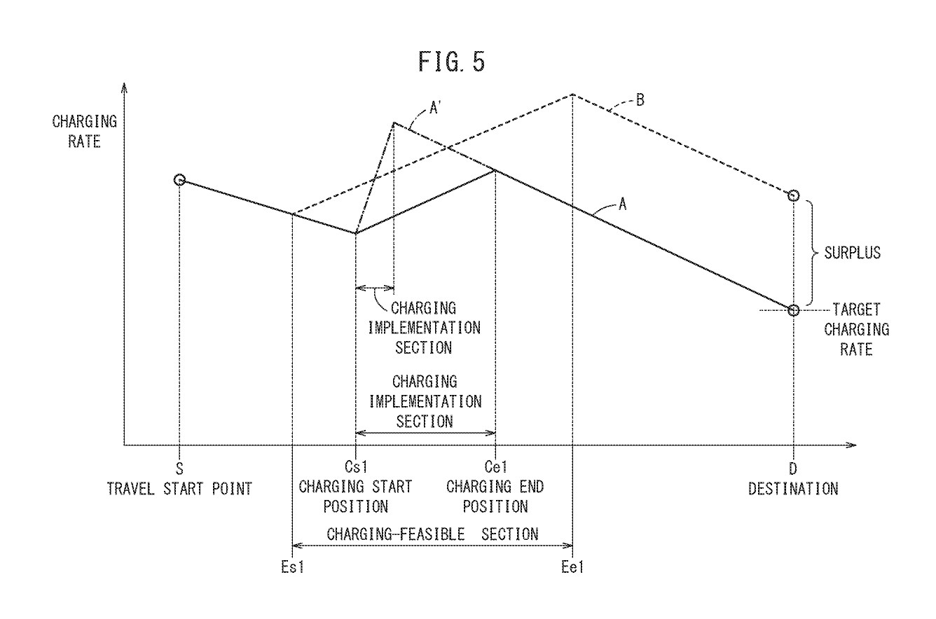

With reference to FIG. 5, description is made of the transition of the charging rate while the electric vehicle 40 travels from a travel start point S to a destination D. A solid line A expresses the transition of the charging rate in a case where the charging is performed in a part of the charging possible section, and this transition corresponds to the transition of the charging rate in the present embodiment. A dashed line B expresses the transition of the charging rate in the case where the charging is performed in the entire charging possible section, and this transition corresponds to the transition in a comparative example of the present embodiment.

As expressed by the solid line A, when the electric vehicle 40 starts to travel from the travel start point S, the electric power is consumed and the charging rate of the battery 56 decreases along the travel. Although the electric vehicle 40 travels in the charging possible section, the secondary side control unit 60 does not perform charging before the electric vehicle 40 reaches a charging start position Cs1. The secondary side control unit 60 starts the charging when the electric vehicle 40 has reached the charging start position Cs1. While the electric vehicle 40 travels in the charging implementation section, the electric power transmitted from the primary coil 28 of the road side facility 20 is received in the secondary coil 44. While the electric vehicle 40 travels, the battery 56 is charged and discharged; here, it is assumed that the charging amount is more than the discharging amount. As the electric vehicle 40 travels in the charging implementation section, the charging rate of the battery 56 increases. Even if the electric vehicle 40 travels in the charging possible section, the secondary side control unit 60 ends the charging when the electric vehicle 40 has reached a charging end position Ce1. When the electric vehicle 40 travels from the charging end position Ce1 to the destination D, the electric power is consumed and the charging rate of the battery 56 decreases along the travel. When the electric vehicle 40 has reached the destination D, the charging rate becomes the target charging rate.

If the electric power transmitted from the primary coil 28 of the road side facility 20 is always received by the secondary coil 44 between a start position Es1 and an end position Ee1 of the charging possible section as expressed by the dashed line B, the charging rate becomes too large at the destination D. This charging amount is a surplus. If the usage fee of the electric power transmitted from the road side facility 20 is very high, the user will be charged very high electric fee.

Alternatively, as shown with a dash-dot line A′, the charging amount per unit time may be increased and at the same time the charging implementation section may be shortened in comparison with the solid line A. The maximum value of the charging amount per unit time depends on the specification of the road side facility 20.

### [4. Second Charging Process]

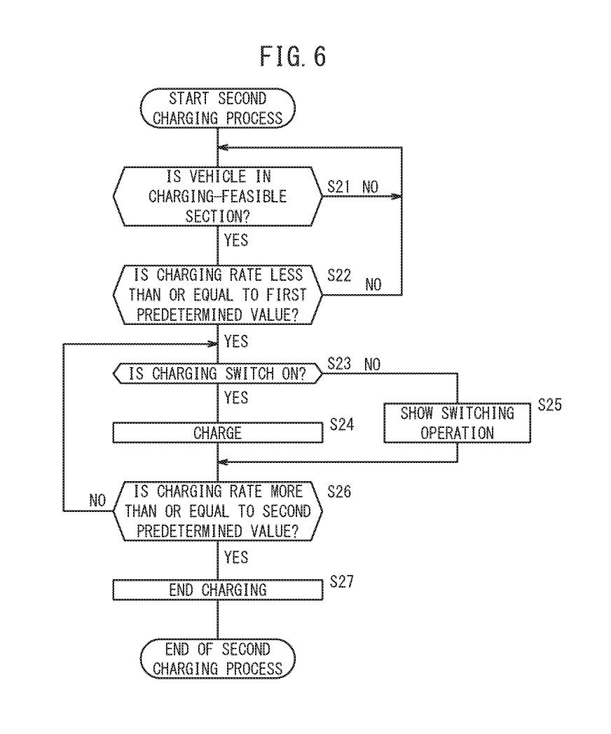

A second charging process is described with reference to FIG. 6. After the electric vehicle 40 passes the charging implementation section, the power consumption may increase and the charging rate of the battery 56 may decrease more than the consumption power amount calculation unit 100 estimates. In this case, when the electric vehicle 40 reaches the destination, the charging rate may be much lower than the target charging rate. In order to prevent such a situation, an additional charging process may be performed. The second charging process to be described below is performed if necessary after the first charging process illustrated in FIG. 4 is performed.

In step S21, the secondary side control unit 60 determines whether the current position of the electric vehicle 40 is in the charging possible section. As illustrated in FIG. 2, the charging power instruction unit 106 acquires the information regarding the current position of the electric vehicle 40 transmitted from the navigation device 70, and the information regarding the scheduled travel route and the charging section information. Then, it is determined whether the current position of the electric vehicle 40 is in the charging possible section. If the current position of the electric vehicle 40 is in the charging possible section (step S21: YES), the process advances to step S22. On the other hand, if the current position of the electric vehicle 40 is out of the charging possible section (step S21: NO), the process of step S21 is repeated.

When the process has advanced from step S21 to step S22, the secondary side control unit 60 determines whether the current charging rate is less than or equal to a first predetermined value. The first predetermined value is a threshold provided to prevent the charging rate of the battery 56 from decreasing more than necessary. The first predetermined value may be a value stored in the storage device 64, a value obtained by adding a certain value to the target charging rate, or a value calculated on the basis of the current charging rate and the target charging rate. If the current charging rate is less than or equal to the first predetermined value (step S22: YES), the process advances to step S23. On the other hand, if the current charging rate is more than the first predetermined value (step S22: NO), the process returns to step S21.

When the process has advanced from step S22 to step S23, the secondary side control unit 60 determines whether the operation switch (charging switch) of the power reception possibility designating device 74 is on. If the operation switch (charging switch) is on (step S23: YES), the process advances to step S24. On the other hand, if the operation switch (charging switch) is off (step S23: NO), the process advances to step S25.

When the process has advanced from step S23 to step S24, the secondary side control unit 60 charges the battery 56. When the charging is started, the secondary side control unit 60 outputs the connection instruction signal to the contactor 54. The contactor 54 becomes the connected state in accordance with the connection instruction. Next, the charging power instruction unit 106 outputs the power instruction signal expressing the instruction value of the charging power to the power regulator 52. As the charging power, a predetermine value stored in the storage device 64 may be set or a calculated value based on the circumstance at that time (such as the amount of electric power consumed before the destination, the target charging rate, and the current charging rate) may be set. The power regulator 52 sets the charging power of the battery 56 as the instruction value.

When the process has advanced from step S23 to step S25, the secondary side control unit 60 outputs the guidance instruction signal of the switching operation to the notification device 80. The notification device 80 notifies that the charging from the road side facility 20 is started by switching the operation switch (charging switch) of the power reception possibility designating device 74 from the off state to the on state in accordance with the guidance instruction.

In step S26, the secondary side control unit 60 determines whether the current charging rate is more than or equal to a second predetermined value. The second predetermined value is a threshold provided to prevent the charging rate of the battery 56 from increasing more than necessary. The second predetermined value may be a value stored in the storage device 64, a value obtained by adding a certain value to the current charging rate at the start of the charging, or a value calculated on the basis of the current charging rate at the start of the charging and the target charging rate. Needless to say, the second predetermined value is more than the first predetermined value. If the current charging rate is more than or equal to the second predetermined value (step S26: YES), the process advances to step S27. On the other hand, if the current charging rate is less than the second predetermined value (step S26: NO), the process returns to step S23.

When the process has advanced from step S26 to step S27, the secondary side control unit 60 ends the charging of the battery 56. The secondary side control unit 60 outputs the shutdown instruction signal to the contactor 54. The contactor 54 is shutdown in accordance with the shutdown instruction. Thus, the charging process ends.

By repeating the second charging process described above, it is possible to prevent the situation in which the charging rate is too low at the destination.

### [5. Transition 2 of Charging Rate of Battery 56]

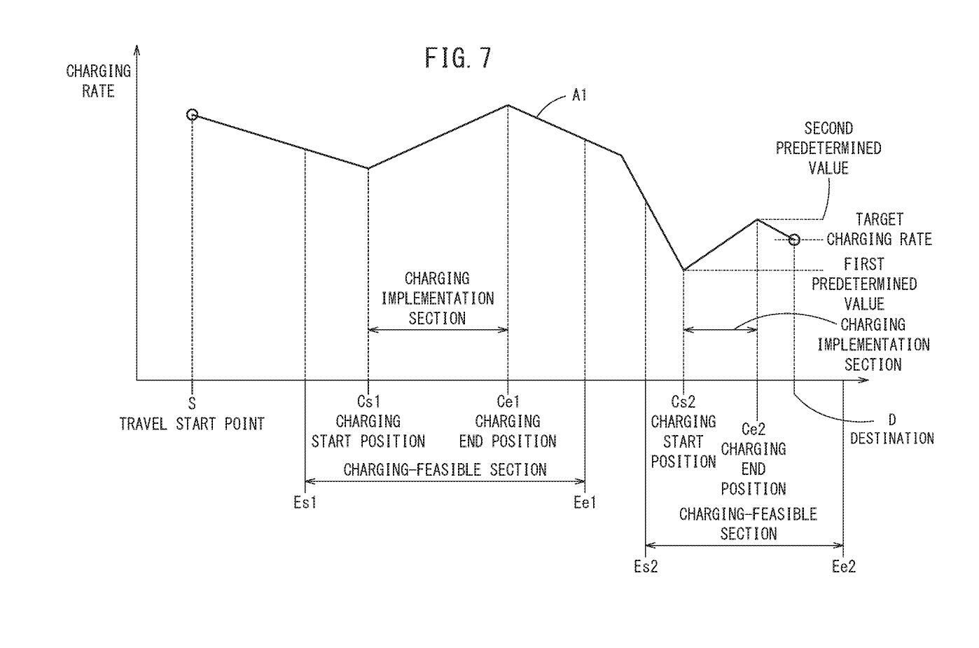

With reference to FIG. 7, description is made of the transition of the charging rate while the electric vehicle 40 travels from the travel start point S to the destination D. The comparison between the transition of the solid line A1 in FIG. 7 and the transition of the solid line A in FIG. 5 indicates that these transitions are different in the transition of the charging rate after the electric vehicle 40 passes the charging end position Ce1.

As expressed by the solid line A1, when the electric vehicle 40 has passed the charging end position Ce1 and then the consumption in the battery 56 increases, the charging rate largely decreases. The secondary side control unit 60 starts to charge when the charging rate becomes less than or equal to the first predetermined value. It is assumed that the position at which the electric vehicle 40 travels at this time point is a charging start position Cs2. The secondary side control unit 60 ends the charging when the charging rate becomes more than or equal to the second predetermined value. It is assumed that the position at which the electric vehicle 40 travels at this time point is a charging end position Ce2. When the electric vehicle 40 travels from the charging end position Ce2 to the destination D, the electric power is consumed and the charging rate of the battery 56 decreases along the travel. When the electric vehicle 40 has reached the destination D, the charging rate is approximately the target charging rate.

### [6. Summary of Embodiment]

In the electric vehicle 40 according to the embodiment described above, the battery 56 is charged by receiving the electric power transmitted from the road side facility 20 provided along the road 14. The electric vehicle 40 includes the secondary side control unit 60 (control unit) configured to switch whether to receive the electric power, and to control the amount of reception power on the basis of the amount of electric power to be consumed while the electric vehicle 40 travels to the destination, the current charging rate of the battery 56, and the target charging rate of the battery 56.

According to the above structure, the amount of reception power from the road side facility 20 is controlled on the basis of the amount of electric power to be consumed while the electric vehicle travels to the destination and the target charging rate; therefore, the electric power is not received from the road side facility 20 more than necessary. If the usage fee of the electric power transmitted from the road side facility 20 is higher than the usage fee of the electric power transmitted from the charging station or the house side facility, the user pays less by decreasing the proportion of the electric power that is received from the road side facility 20.

The electric vehicle 40 further includes the charging rate designating device 72 configured to designate the target charging rate in accordance with the manual operation. By the above structure, the user can select whether the amount of reception power from the road side facility 20 is increased or minimized while considering a driving plan or the like that is carried out after the user reaches the destination. As a result, the use of the electric vehicle 40 becomes more convenient.

The electric vehicle 40 further includes the power reception possibility designating device 74 configured to designate whether to receive the electric power in accordance with the manual operation. The secondary side control unit 60 is configured to switch whether to receive the electric power in accordance with the designation (on/off signal) of the power reception possibility designating device 74. By the above structure, if the user does not want to receive the electric power from the road side facility 20, the power reception can be blocked by the manual operation. Thus, the user her/himself can control the electric fee.

In the second charging process illustrated in FIG. 6, the secondary side control unit 60 receives the electric power when the current charging rate is less than or equal to the first predetermined value (step S22 to step S24 in FIG. 6). By the above structure, the charging is not started until the charging rate becomes less than or equal to the first predetermined value that is set in advance; thus, the amount of reception power from the road side facility 20 can be minimized.

The electric vehicle 40 includes the notification device 80 configured to notify in accordance with the notification instruction output from the secondary side control unit 60. The secondary side control unit 60 outputs the notification instruction to the notification device 80 when the target charging rate is not achieved (step S5 and step S6 in FIG. 3). With the above structure, the notification is performed if the charging rate could become insufficient before the electric vehicle 40 reaches the destination. Thus, the user can prioritize the charging more than reducing the amount of reception power from the road side facility 20. For example, the scheduled travel route can be changed to the road 14 with a long charging possible section, or the electric vehicle can drop by the charging station for charging.

When the destination is a predetermined place, the secondary side control unit 60 sets the target charging rate to the value lower than the value given when the destination is not the predetermined place (step S3 and step S4 in FIG. 3). With the above structure, if the destination is the place where the usage fee of the electric power is low, for example, the destination is the house or the like, the target charging rate can be set to a minimal value, and the amount of reception power from the road side facility 20 can be suppressed.

The electric vehicle according to the present invention is not limited to the above embodiment and may employ various structures without departing from the concept of the present invention.

What is claimed is:

1. An electric vehicle in which a battery is charged by receiving electric power transmitted from a road side facility provided along a road, the electric vehicle comprising a control unit configured to switch whether to receive the electric power, and to control the amount of reception power on the basis of the amount of electric power to be consumed while the electric vehicle travels to a destination, a current charging rate of the battery, and a target charging rate of the battery.

2. The electric vehicle according to claim 1, further comprising a charging rate designating device configured to designate the target charging rate in accordance with a manual operation.

3. The electric vehicle according to claim 1, further comprising a power reception possibility designating device configured to designate whether to receive the electric power in accordance with a manual operation, wherein the control unit is configured to switch whether to receive the electric power in accordance with the designation of the power reception possibility designating device.

4. The electric vehicle according to claim 1, wherein the control unit is configured to receive the electric power when the current charging rate is less than or equal to a predetermined value.

5. The electric vehicle according to claim 1, further comprising a notification device configured to notify in accordance with a notification instruction output from the control unit, wherein the control unit is configured to output the notification instruction to the notification device when the target charging rate is not achieved.

6. The electric vehicle according to claim 1, wherein when the destination is a predetermined place, the control unit is configured to set the target charging rate to a value lower than a value given when the destination is not the predetermined place.
